(19) United States
(12) Patent Application Publication
(10) Pub. No.: US 2014/0085146 A1
(43) Pub. Date: Mar. 27, 2014

(54) ANTENNA DEVICE

(71) Applicant: ALPS ELECTRIC CO., LTD., Tokyo (JP)

(72) Inventors: Toshiyuki Azuma, Miyagi-Ken (JP); Satoru Matsuzaki, Miyagi-Ken (JP); Satoru Chida, Miyagi-Ken (JP)

(21) Appl. No.: 13/973,726

(22) Filed: Aug. 22, 2013

(30) Foreign Application Priority Data
Sep. 27, 2012 (JP) 2012-214750

(51) Int. Cl. H01Q 1/38

(52) U.S. Cl. CPC H01Q 1/38
USPC 343/700 MS

(57) ABSTRACT

An antenna device can be placed on an insulation substrate having a wiring pattern and has an antenna member including an antenna radiation element, a mounting terminal, a power supply terminal formed continuously to the antenna radiation element, and the antenna member is formed by an insert molding with resin. The antenna device includes; a top surface portion that is parallel with respect to the surface of the insulation substrate when the device is placed on the insulation substrate, and a leg portion that is orthogonal with respect to the surface of the insulation substrate when the device is placed on the insulation substrate. The antenna radiation element is disposed on the top surface portion, and the mounting terminal and the power supply terminal are disposed only on the leg portion.

### CLAIM OF PRIORITY

This application claims benefit of Japanese Patent Application No. 2012-214750 filed on Sep. 27, 2012, which is hereby incorporated by reference in its entirety.

### BACKGROUND

1. Field of the Disclosure

The present disclosure relates to an antenna device, particularly to an antenna device formed from insert molding with resin.

2. Description of the Related Art

In the related art, as an antenna device that uses an antenna radiation element made of a sheet of metal plate is used for a wireless LAN (Local Area Network; a GPS (Global Positioning System) in mobile equipment or a camera. In such an antenna device, an antenna device having a plurality of mounting terminals for supporting the antenna radiation element, and the antenna radiation element and the plurality of mounting terminals integrated by resin has been proposed.

For example, an antenna device 935 illustrated in FIG. 5A and FIG. 5B, and disclosed in Japanese Unexamined Patent Application Publication No. 2005-150910 includes an antenna radiation element 923, a plurality of mounting terminals 927 for supporting the antenna radiation element 923. In the antenna radiation element 923, a power supply terminal 929 and a ground terminal 931 are formed. Hence, an inverted-F shaped antenna is configured with the antenna radiation element 923, the power supply terminal 929 and the ground terminal 931.

In addition, steps of manufacturing the antenna device 935 include a step of punching the metal plate and forming the shape of the antenna radiation element 923 and the mounting terminal 927 and a step of insert molding of the antenna radiation element 923 and the mounting terminal 927 by the resin 933. Then, the process proceeds to the final step via the step of separating the insert molded and integrated antenna device 935 from the metal plate.

Then, in the final step, the configuration of the antenna 935 is completed by bending the plurality of mounting terminal 927, the power supply terminal 929 and the ground terminal 931 in a predetermined direction as illustrated in FIG. 5B.

However, such an antenna device 935 in the related art has problems as described below. That is, in order to efficiently manufacture the antenna device 935 with a metal plate having a certain size, the antenna radiation element 923 and the plurality of mounting terminals 927 are configured on the same plane to match the final placement as illustrated in FIG. 5A. As a result, an antenna radiation surface of the antenna device 935 is occupied by the plurality of mounting terminal 927 as well as the antenna radiation element 923. Therefore, the size of the antenna radiation element 923 is decreased by as much as the size on which the plurality of mounting terminals 927 are present. Therefore, the performance of the antenna device 935 decreases as much as the size of the antenna radiation element 923 decreases. In addition, conversely, in case of trying to increase the antenna radiation element 923 such that the performance is not decreased, there is a problem in that it is inevitable to increase the size of the antenna device 935 by as much as the size of the plurality of mounting terminals 927. As an antenna device accommodated in the housing of the mobile equipment or the camera, since the minimal size of the antenna device is required, it is necessary to repress the increase of the size of the antenna device.

### SUMMARY

An antenna device according to an embodiment of the present invention can be placed on an insulation substrate having a wiring pattern and has an antenna member including an antenna radiation element, a mounting terminal, a power supply terminal formed continuously to the antenna radiation element, and the antenna member is formed from insert molding with resin. The antenna device includes; a top surface portion that is parallel with respect to the surface of the insulation substrate when the device is placed on the insulation substrate, and a leg portion that is orthogonal with respect to the surface of the insulation substrate when the device is placed on the insulation substrate. The antenna radiation element is disposed on the top surface portion, and the mounting terminal and the power supply terminal are disposed only on the leg portion.

In the antenna device configured as described above according to the present invention, since the top surface portion which is an antenna radiation surface can be occupied only by the antenna radiation element, it is possible to provide the antenna device by which a maximum antenna performance can be obtained without increasing the size thereof.

### BRIEF DESCRIPTION OF THE DRAWINGS

FIG. 1 is a perspective view illustrating an antenna member before the insert molding on the antenna device according to an embodiment of the present invention.

FIG. 2 is a perspective view illustrating an antenna member after the insert molding on the antenna device according to the present invention.

FIG. 3 is a perspective view illustrating the antenna device according to t an embodiment of he present invention.

FIG. 4A is a plan view and FIG. 4B is a cross-sectional view seen along the IVB-IVB line in FIG. 4A, which are illustrating an antenna device according to an embodiment of the present invention.

FIGS. 5A and 5B are views illustrating the antenna device according to an example in the related art.

### DESCRIPTION OF THE EXEMPLARY EMBODIMENTS

### Embodiments

Hereafter, the embodiments according to the present invention will be described with reference to the drawings.

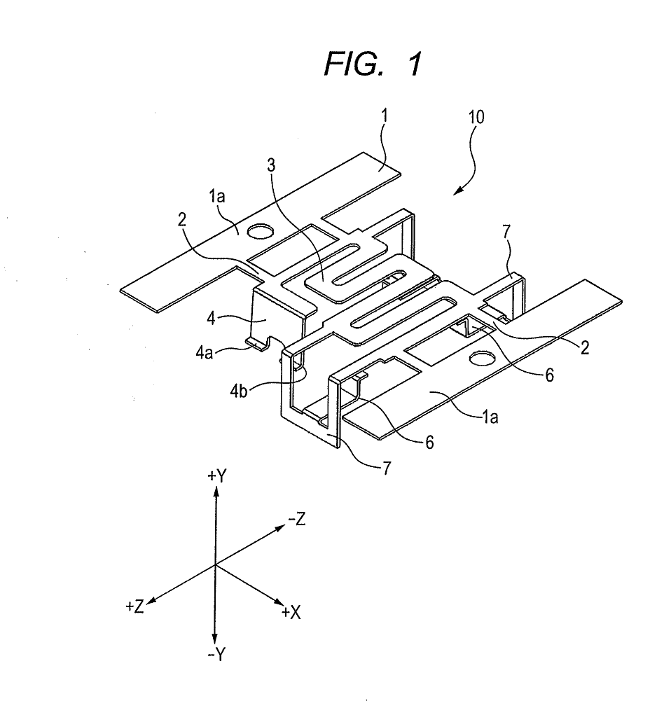

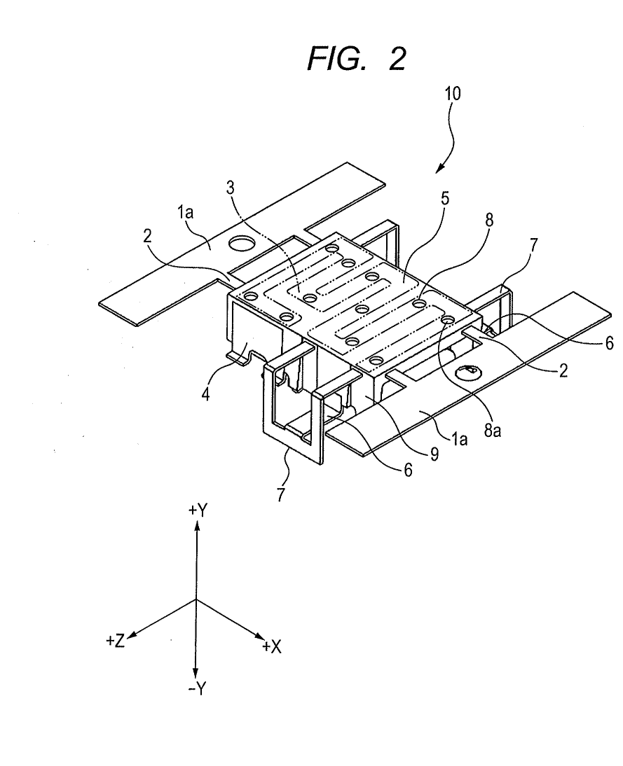

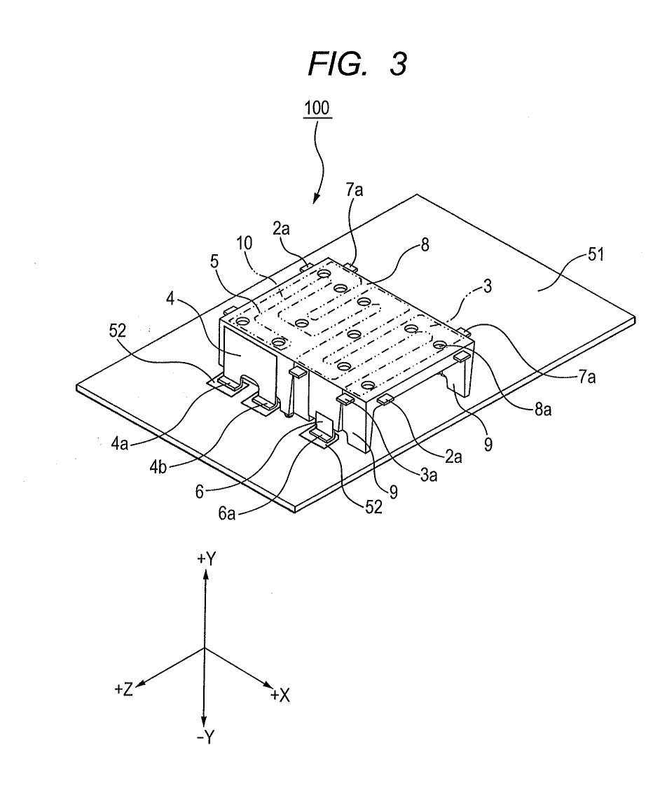

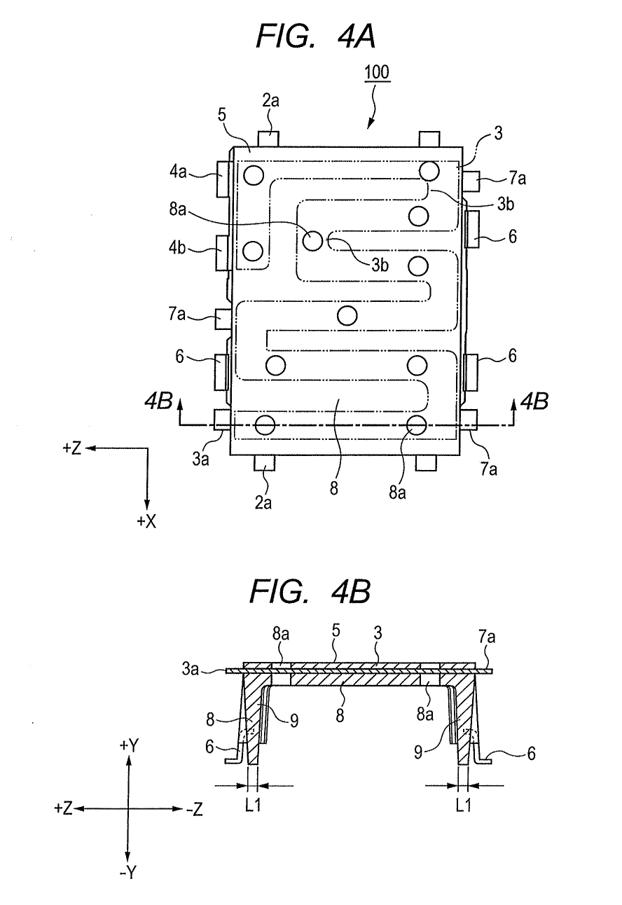

An antenna device in the embodiment of the present invention is the antenna device manufactured based on an antenna member formed of metal. FIG. 1 illustrates the antenna member in the process of manufacturing the antenna device in the embodiment of the present invention, and is a perspective view of the antenna member before the insert molding after the bending process. FIG. 2 is a perspective view illustrating the antenna device after the insert molding of the resin with respect the antenna member in FIG. 1. FIG. 3 is a perspective view illustrating the antenna device after cutting and removing of the connection section with respect to the insert molded antenna member in FIG. 2. In addition, FIG. 4A and FIG. 4B illustrate the antenna device in the embodiment of the present invention, FIG. 4A is a plan view and FIG. 4B is a cross-sectional view seen along the IVB-IVB line in FIG. 4A.

The antenna device 100 in the embodiment of the present invention illustrated in FIG. 3 is assembled as described below. First, the antenna member 10 is formed by punching a metal plate 1 to fit the antenna shape, and bending the punched metal plate 1 as illustrated in FIG. 1. The antenna member 10 includes an antenna radiation element 3, a mounting terminal 6 and a power supply terminal 4 which is formed continuously to the antenna radiation element 3. Then, as illustrated in FIG. 2, the antenna member 10 is insert molded by resin 8 and then the configuration of the antenna device 100 illustrated in FIG. 3 is completed after a first connection section 2 and a second connection section 7 are cut and removed.

Hereafter, the process of manufacturing the antenna device 100 will be further described in detail.

In the antenna member 10 in the process of manufacturing, as illustrated in FIG. 1, two first connection sections 2 are extended to be formed, from each of two metal plate ear portions la of the metal plate 1. Then, the antenna member 10 has a structure in which the four first connection sections 2 connected to the metal plate ear portions la support the antenna radiation element 3 from both sides. The antenna radiation element 3 has a meandering shape in order to secure the antenna length of the antenna element in a limited area. In addition, the power supply terminal 4 is formed continuously in a part of meandering-shaped antenna radiation element 3. Then, at the distal end portion of the power supply terminal 4, a power supply terminal supply end portion 4a which is a power supply point and a power supply terminal ground end portion 4b which is a ground point, are formed. The power supply terminal 4 is formed by being bent substantially perpendicular (−Y direction) to the antenna radiation element 3. Moreover, in the antenna device 100 in the embodiment of the present invention, an inverted F-shaped antenna is configured with the antenna radiation element 3, the power supply terminal supply end portion 4a and the power supply terminal ground end portion 4b.

In the antenna member 10, as illustrated in FIG. 1, the second connection section 7 connected to the antenna radiation element 3 and the mounting terminal 6 connected to the distal end of the second connection section 7 are further formed. The mounting terminal 6, as illustrated in FIG. 3, is a terminal which connects and fixes the antenna device 100 main body to a wiring pattern 52 on an insulation substrate 51 by soldering. The second connection section 7, as illustrated in FIG. 1, is bent in −Y direction at the tip extended from the antenna radiation element 3 and bent again in −Z or +Z direction at the tip thereof. Moreover, the mounting terminal 6 is formed in a shape in which the distal end portion of the second connection section 7 is further bent in +Y direction.

As illustrated in FIG. 2, an insert molding is performed on the antenna member 10 where the bending process is finished, in which the entire portion of the antenna radiation element 3, a part of each of the power supply terminal 4 and the mounting terminal 6 of the antenna member 10 are covered by the resin 8. Here, in the antenna device 100 in the embodiment of the present invention, the power supply terminal 4 is provided along the side surface of the external side of a leg portion 9, and an opposite side surface to the antenna radiation element 3 side is exposed from the resin 8. Moreover, the exposed surface of the power supply terminal 4 may be the antenna radiation 3 side, not limited to the opposite side to the antenna radiation element 3 side. That is, the surface of at least any one side of the power supply terminal 4 may be exposed with respect to the outside from the resin 8.

The antenna device 100 in the embodiment of the present invention configures the inverted F-shaped antenna as described above. However, in case of the inverted F-shaped antenna, the electric field strength in the vicinity of the power supply terminal 4 is high. Thus, the dielectric loss of the resin 8 which covers the power supply terminal 4 gives a large influence to the antenna gain. Therefore, by exposing the power supply terminal 4 to the outside from the resin 8, the dielectric loss can be decreased and the antenna gain can be increased.

The resin 8 covers the antenna radiation element 3, the power supply terminal 4 and the mounting terminal 6. However, a part covering the antenna radiation element 3 forms a top surface portion 5, and a part covering the power supply terminal 4 and the mounting terminal 6 forms the leg portion 9.

As illustrated in FIG. 3, the top surface portion 5 is formed so as to be parallel with respect to the surface of the insulation substrate 51 when the antenna device 100 is placed on the insulation substrate 51. In addition, the leg portion 9 is formed so as to be vertical with respect to the surface of the insulation substrate 51 when the antenna device 100 is placed on the insulation substrate 51.

As illustrated in FIG. 4A and FIG. 4B, in the top surface portion 5 of the antenna device 100, the antenna radiation element 3 is disposed in the inner side of the resin 8, and the mounting terminal 6 does not present on the same plane where the antenna radiation element 3 presents. That is, the mounting terminal 6 and the power supply terminal 4 are disposed only on the leg portion 9, and only the antenna radiation element 3 besides the resin 8 is disposed on the top surface portion 5. Therefore, the top surface portion 5, that is, the entire surface of the antenna radiation surface to be acceptable as the antenna device 100, can be totally occupied by the antenna radiation element 3 only. Therefore, it is possible to maximize the performance of the antenna device 100. In addition, since there is no other configuration element such as the mounting terminal 6 on the top surface portion 5 in the antenna device 100, it is possible to contribute to the decrease in the size of the antenna device 100 without the increase in the size of the antenna device 100.

In addition, as illustrated in FIG. 4B, since the mounting terminal 6 is disposed at the position separated a certain distance from the antenna radiation element 3, the parasitic capacitance does not occur between the antenna radiation element 3 and the mounting terminal 6, and the mounting terminal 6 does not give an influence to the antenna performance of the antenna radiation element 3.

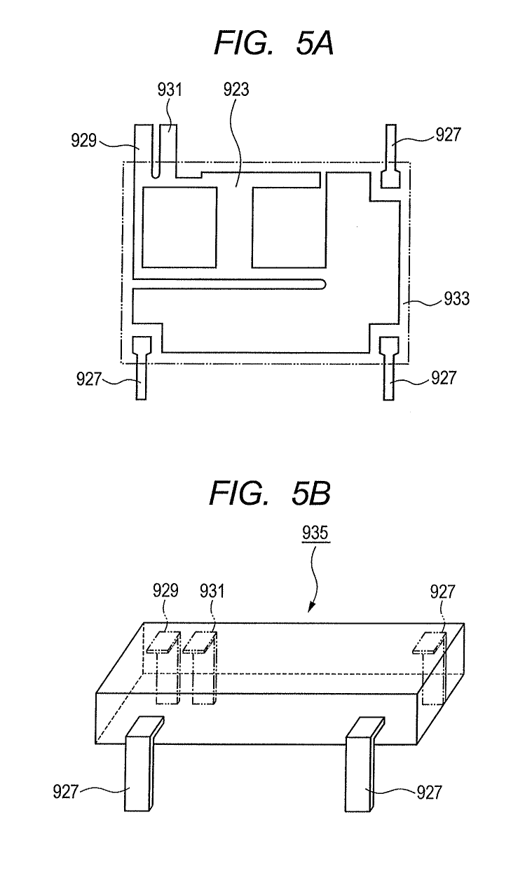

In addition, as illustrated in FIG. 4B, by being embedded in the resin 8, the mounting terminal 6 is integrated to the antenna device 100 and the mounting position of the mounting terminal 6 is determined. Furthermore, in the antenna device 100 in the embodiment of the present invention, a supporting method in which the antenna device 100 main body is supported by the leg portion 9 formed of the resin 8 is adopted rather than the supporting method in which the antenna device is supported by the mounting terminal 927, the power supply terminal 929 and the grounding terminal 931 as in the related art illustrated in FIG. 5. Since the thickness of the metal plate forming the mounting terminal 6 and the power supply terminal 4 recently have become very thin, it is extremely difficult to stably support the antenna device 100 main body only by the mounting terminal 6 and the power supply terminal 4 as in the related art illustrated in FIG. 5.

As illustrated in FIG. 4B, the resin 8 in the leg portion 9 is formed so as to have a predetermined thickness L1, and the antenna device 100 can be placed on the insulation substrate 51 by the leg portion 9 having a predetermined thickness L1 as illustrated in FIG. 3. Here, the predetermined thickness L1 is set to the thickness by which the antenna device 100 main body can be supported. As a result, even though the thickness of the metal plate configuring the mounting terminal 6 or the power supply terminal 4 is thin, the antenna device 100 main body can stably be supported. In addition, the leg portion 9 has the predetermined thickness L1, and in order to efficiently support the antenna device 100 main body by the less amount of the resin 8, the shape thereof is also considered to be set.

The shape of the antenna device 100 is a shape that the top surface portion 5 and the leg portion 9 are combined. As a result, the antenna device 100 is formed so as to have a substantially U-shape in cross-section, as illustrated in FIG. 4B. In this manner, by forming the antenna device 100 in a shape of substantially U-shape in cross-section, a space can be provided between the top surface portion 5 and the insulation substrate 51 of the antenna device 100 as illustrated in FIG. 3. Therefore, electronic components can be mounted in the space and it is possible to effectively utilize the component mounting region of the insulation substrate 51.

Furthermore, as illustrated in FIG. 3, the antenna device 100 is mounted on the insulation substrate 51, and the power supply terminal 4 and the mounting terminal 6 can be connected to the wiring pattern 52 on the insulation substrate 51 by soldering. Therefore, each of a solder connection portion of the power supply terminal supply end portion 4a and the power supply terminal ground end portion 4b of the power supply terminal 4, and the mounting terminal mounting end portion 6a of the mounting terminal 6, can be exposed from the resin 8.

As illustrated in FIG. 2, FIG. 3, FIG. 4A and FIG. 4B, in the insert molded antenna member 10, a plurality of resin hole portions 8a are formed over the surface of the antenna radiation element 3 from the surface of the resin 8 of the top surface portion 5. The resin hole portions 8a are also formed on the bottom side (−Y direction) with respect to the surface of the antenna radiation element 3 as well as on the upper side (+Y direction) thereof as illustrated in FIG. 4B. The resin hole portions 8a are punching traces of the mold (not illustrated) which supports the antenna radiation element 3 from the top and bottom when performing the insert molding for covering the antenna member 10 by the resin 8. Since the mold which supports the antenna radiation element 3 from the top and down when performing the insert molding is necessary for performing insert molding stably, it is natural that the resin hole portions 8a are formed, as a result.

Therefore, the antenna radiation element 3 is exposed to the outside via the resin hole portions 8a. In this way, since the dielectric loss can be decreased by exposing the antenna radiation element 3 at position of the resin hole portions 8a, it is possible to prevent the antenna gain from decreasing.

In a case where the antenna radiation element 3 has a meandering shape, there is a possibility that a bent portion of the meandering shape may decrease the antenna performance to a certain extent. However, as illustrated in FIG. 4A, by providing the resin hole portions 8a in the vicinity of the antenna radiation element bent portion 3b of the antenna radiation element 3 having the meandering shape, the dielectric loss in the space in the vicinity of the bent portion can be decreased, and it is possible to prevent the antenna performance from decreasing.

In addition, as illustrated in FIG. 4A and FIG. 4B, a first connection section remained portion 2a and a second connection section remained portion 7a protruding to the outside of the resin 8 to be remained as a part of the antenna radiation element 3 even after the cutting of the first connection section 2 and the second connection section 7. By the first connection section remained portion 2a and the second connection section remained portion 7a protruding to the outside of the resin 8 as a part of the antenna radiation element 3, the dielectric loss in the part can be decreased, it is possible to increase the antenna gain. In particular, since an antenna radiation element open end portion 3a at the distal end portion of the antenna radiation element 3 is positioned at the position where the electric field strength is the highest, by exposing the antenna radiation element open end portion 3a to the outside from the resin 8, the antenna radiation element open end portion 3a contributes to further increase the antenna gain.

As described above, the antenna device 100 in the embodiment includes a top surface portion 5 that is parallel with respect to the surface of the insulation substrate 51 when the device is placed on the insulation substrate 51, and a leg portion 9 that is orthogonal with respect to the surface of the insulation substrate 51 when the device is placed on the insulation substrate 51. The antenna radiation element 3 is disposed on the top surface portion 5. The mounting terminal 6 and the power supply terminal 4 are disposed only on the leg portion 9.

In the antenna device 100 configured as described above, in the embodiment of the present invention, since the top surface portion 5 which is an antenna radiation surface can be occupied only by the antenna radiation element 3, it is possible to provide the antenna device 100 by which a maximum antenna performance can be obtained without increasing the size thereof.

It should be understood by those skilled in the art that various modifications, combinations, sub-combinations and alterations may occur depending on design requirements and other factors insofar as they are within the scope of the appended claims of the equivalents thereof.

What is claimed is:

1. An antenna device that can be placed on an insulation substrate having a wiring pattern and has an antenna member including an antenna radiation element, a mounting terminal, a power supply terminal, the device comprising:
a top surface portion that is parallel with respect to the surface of the insulation substrate when the device is placed on the insulation substrate; and
a leg portion that is orthogonal with respect to the surface of the insulation substrate when the device is placed on the insulation substrate,
wherein the antenna radiation element is disposed on the top surface portion, and
wherein the mounting terminal and the power supply terminal are disposed only on the leg portion.

2. The antenna device according to claim 1:
wherein the antenna member is formed by an insert molding with resin,
wherein the resin in the leg portion has a thickness that supports the antenna device main body, and
wherein the leg portion is configured to be placed on the insulation substrate.

3. The antenna device according to claim 1:
wherein the antenna member is formed by an insert molding with resin,
wherein a power supply terminal supply end portion and a power supply terminal ground end portion are provided on the power supply terminal, and the inverted F-shaped antenna is configured by the antenna radiation element, the power supply terminal supply end portion and a power supply terminal ground end portion, and
wherein the power supply terminal is provided along the side surface of the leg portion, and at least one surface of the power supply terminal is exposed from the resin.

4. The antenna device according to claim 1,
wherein the antenna member is formed by an insert molding with resin, and
wherein an antenna radiation element open end portion of the antenna radiation element is exposed from the resin.

5. The antenna device according to claim 1,
wherein the antenna member is formed by an insert molding with resin,
wherein a plurality of resin hole portions are provided on the resin of the top surface portion, and a part of the antenna radiation element is exposed from the resin hole portion.

6. The antenna device according to claim 5,
wherein the antenna radiation element has a meandering shape, and the resin hole portions are provided in the vicinity of the meandering-shaped antenna radiation element bent portion.
